(19) United States
(12) Patent Application Publication
(10) Pub. No.: US 2019/0134713 A1
(43) Pub. Date: May 9, 2019

(54) ADDITIVE MANUFACTURING

(71) Applicant: Hewlett-Packard Development Company, L.P., Houston, TX (US)

(72) Inventors: James Elmer Abbott, JR., Corvallis, OR (US); Vladek Kasperchik, Corvallis, OR (US)

(73) Assignee: Hewlett-Packard Development Company, L.P., Houston, TX (US)

(21) Appl. No.: 16/098,078

(22) PCT Filed: Jul. 22, 2016
(86) PCT No.: PCT/US2016/043654

§ 371 Date: Oct. 31, 2018

(51) Int. Cl. B22F 3/24; B22F 3/00; B29C 64/165; B33Y 10/00; B33Y 70/00; B33Y 40/00; C22C 1/04

(52) U.S. Cl. CPC B22F 3/24; B22F 3/008; B29C 64/165; B33Y 10/00; B22F 2999/00; B33Y 40/00; C22C 1/0425; B22F 2003/248; B22F 2998/10; B33Y 70/00

(57) ABSTRACT

Additive manufacturing includes forming a three-dimensional (3D) object by depositing a layer of a powdered build material onto a surface, selectively depositing a first liquid that includes a binder onto the layer of the powdered build material in a first pattern, selectively depositing a second liquid that includes reducible metal oxide particles in a second pattern onto the layer of powdered build material, and heating the object in the presence of at least one reducing agent to sinter the solid particles delivered with either the first liquid or the second liquid and the powdered build material and reduce the metal oxide particles to a metallic state.

### BACKGROUND

An additive manufacturing device is used to produce a three-dimensional (3D) object. The additive manufacturing device produces the 3D object by depositing layers of build material corresponding to slices of a computer-aided design (CAD) model that represents the 3D object. Some additive manufacturing machines are referred to as 3D printing devices because they use types of printing technology to deposit some of the manufacturing materials.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a flowchart of an example method for additive manufacturing to produce an object that includes both metallic and non-metallic portions, consistent with the disclosed implementations.

FIG. 2 is a diagram of integration of metallic and non-metallic portions into an example object produced by an additive manufacturing process, shown prior to sintering, consistent with the disclosed implementations.

FIG. 3 is a diagram of the object of FIG. 2, shown after sintering, consistent with the disclosed implementations.

FIG. 4 is a cross-sectional diagram of an example object produced by an additive manufacturing device, consistent with the disclosed implementations.

FIG. 5 is a cross-sectional diagram of an example object produced by an additive manufacturing device conducting electricity, consistent with the disclosed implementations.

FIG. 6 is a cross-sectional diagram of an example object produced by an additive manufacturing device with increased fracture toughness due to a metallic pattern within the object, consistent with the disclosed implementations.

FIG. 7 is a diagram of an example object produced by additive manufacturing with increased fracture toughness due to a metallic pattern within the object, consistent with the disclosed implementations.

FIG. 8 is a flowchart of an example of a method for an additive manufacturing process to produce an object that includes both a metallic and a non-metallic portion in a layer-wise fashion, consistent with the disclosed implementations.

FIG. 9 is a diagram of an example of an additive manufacturing device for forming a three-dimensional (3D) object with a metal disposed therein by applying layers of build material and liquids, consistent with the disclosed implementations.

FIG. 10 is a diagram of an example of an additive manufacturing device for forming a 3D object with a metal disposed therein by heating an object included within a chamber, consistent with the disclosed implementations.

FIG. 11 is a diagram of an example of an internal environmental control mechanism for a 3D printing device, consistent with the disclosed implementations.

FIG. 12 is a cross-section of an example object prepared consistent with the disclosed implementations.

FIG. 13 is a scanning electron microscope image prepared from the object shown in FIG. 12, consistent with the disclosed implementations.

### DETAILED DESCRIPTION

As mentioned above, an additive manufacturing device produces a three-dimensional (3D) object from a computer-aided design (CAD) model representing the 3D object. Once the CAD model of the 3D model is created, the CAD model is processed into a number of slices. Each of the slices corresponds to a layer of the 3D object to be produced by the additive manufacturing device. The additive manufacturing device produces a portion of the 3D object by depositing a first layer of build material representing the first slice of the CAD model. The additive manufacturing device then produces subsequent portions of the 3D object by depositing subsequent layers of the build material representing subsequent slices of the CAD model on top of the previous layer until the 3D object is produced.

A number of powderbed-based current additive manufacturing devices use a single liquid material in combination with a single build material when producing the 3D object. The combination of a single build material and a single liquid material produces a homogenous object. To produce a non-homogenous object, a user can combine homogenous objects, or modify the homogenous object to provide a coating, or other similar modifications. It is possible to use more than one liquid material to produce a non-homogenous object; however, producing an object that includes a controlled patterning of both metallic regions and non-metallic regions is beyond the capabilities of current additive manufacturing devices and methods.

A method for additive manufacturing includes forming a 3D object by depositing a layer of a powdered build material onto a surface, selectively depositing a first liquid that includes a binder onto the layer of the powdered build material in a first pattern, selectively depositing a second liquid that includes metal oxide particles in a second pattern onto the layer of powdered build material and heating the object in the presence of at least one reducing agent to sinter the solids delivered with either the first liquid or the second liquid and the powdered build material and reduce the metal oxide particles to a metallic state.

A method for additive manufacturing for preparing a 3D object that comprises metal within an interior includes forming a 3D object by depositing a layer of a powdered build material onto a surface, selectively depositing a first binder fluid that includes at least one reducing agent onto the layer of powdered build material in a first pattern, and selectively depositing a second binder fluid that includes copper(II) oxide particles onto the layer of powdered build material in a second pattern, and heating the object by microwave radiation to reduce the copper(II) oxide particles to metallic copper, and to sinter the powdered build material and the solid particles delivered with either the first liquid or the second liquid. An object so produced is capable of conducting electricity with a resistivity ranging from 1.0 1.0×10⁻⁸ Ohm-meters (Ω·m) to 1.0 Ω·m.

An additive manufacturing device for forming a 3D object with a metal disposed therein includes a chamber that includes a surface on which a 3D object is formed, a number of powdered build material dispensers to dispense layers of a powdered build material into the chamber, a number of liquid dispensers to dispense at least two liquids into the chamber that include a first liquid, and a second liquid that includes reducible metal oxide particles, and a number of heating elements to sinter the solid particles delivered with either the first liquid or the second liquid and the powdered build material, and to reduce at least one metal oxide particle to a metallic state.

According to an example, the layers of the 3D object are assembled by first depositing a layer of the build material onto a surface of the additive manufacturing device used to retain the 3D object. A subsequent later of build material is then applied to the first layer of build material after the first layer of build material is solidified. Each layer of the build material is deposited evenly across the previous layer of build material to provide an even thickness to each layer of the 3D object.

According to one example, liquid is selectively deposited over each layer of the build material. The liquid contains an energy-absorbing material, which may be in the form of solid particles. Where the liquid is deposited on the layer of build material, the liquid solidifies and holds the build material in place. The liquid phase evaporates by, for example, light, heat, evaporation of a volatile liquid, electromagnetic radiation, or any other suitable method; evaporation of the liquid phase leaves solid particles included in the liquid where the liquid was selectively deposited. In an example, the liquid phase evaporates before sintering. In another example, the liquid evaporates before sintering to produce a green body, which is then added to by providing an additional layer of build material or is sintered. However, where the liquid was not deposited, the build material remains free flowing.

The range of 3D objects that can be produced by the additive manufacturing device is expanded upon by incorporating of a number of metallic patterns within the 3D object. The incorporation of metallic patterns within a 3D object prepared by the additive manufacturing device allows production of complex circuitry, 3D objects with increased fracture toughness as well as other benefits.

Control over locations where a metal within a 3D object is deposited is especially valuable. For example, a 3D object that is homogenous and metallic is able to conduct electricity, but to prepare circuitry from such objects would involve separate preparation of the metallic and non-metallic elements of the circuits.

In another example, providing a metallic coating to the outer surface of a 3D object allows that 3D object to conduct electricity through the metallic surface or to act as a chemical catalyst. However, the incorporation of metallic regions within an object provides added control over production, as well as expanding the scope of 3D objects that can be produced by the additive manufacturing device.

Thus, the present specification provides the ability to introduce a metal within a 3D object produced by the additive manufacturing device and to specify the location of the metal within the 3D object. This includes metallic regions within a 3D object such that the 3D object may include complex circuitry. For example, electrical current travels through the metallic regions. However, electrical current does not travel through the non-metallic, dielectric regions. The electrical current may travel around the non-conductive build material disposed within the metallic regions. This build material is used to structure the metallic regions.

A metal within a 3D object may also be used to increase the fracture toughness of the object, if it contains enough metal to form a locally or globally continuous phase. Increasing the fracture toughness of an object is used to increase the durability of the 3D object that is produced by the additive manufacturing device.

However, it is contemplated that the devices and methods disclosed herein may be useful in addressing other matters and deficiencies in a number of technical areas. Therefore, the devices and methods disclosed herein should not be construed as addressing any of the particular matters.

In the present specification and the appended claims, the term “measurable resistance” means that the difficulty of passing electrical current is quantifiable. A measurable resistance indicates that the material is capable of conducting electricity. The ability of a material to conduct electricity is measured by using a digital multimeter.

In the present specification and in the appended claims, the term “resistivity” refers to a property of a material. Specifically, resistivity corresponds to the electrical resistance that is provided by a cross-sectional area of the material per unit of length through which the resistance is measured. Resistivity is measured in Ohm-meters (Ω·m). Unless stated otherwise, in the present specification, resistivity is measured at 20 degrees Celsius.

In the present specification and the appended claims, the term “fracture toughness” means the ability of a 3D object that is cracked to resist fracture under application of stress. Fracture toughness relates to a property of a material, whether the material is homogenous or heterogeneous.

In the present specification and the appended claims, the term “allotropes” of an element or a compound means different structural arrangements of the element or compound. For example, allotropes of carbon include diamond, graphite, fullerenes, carbon nanotubes, and amorphous carbon.

Further, as used in the present specification and in the appended claims, the term “a number of” or similar language is meant to be understood broadly as any positive number greater than or equal to 1.

In the following description, for purposes of explanation, numerous specific details are set forth in order to provide a thorough understanding of the present devices and methods. It will be apparent, however, to one skilled in the art that the present apparatus, systems and methods may be practiced without these specific details. Reference in the specification to “an example” or similar language provides that a particular feature, structure, or characteristic described in connection with that example is included as described, but may not be included in other examples.

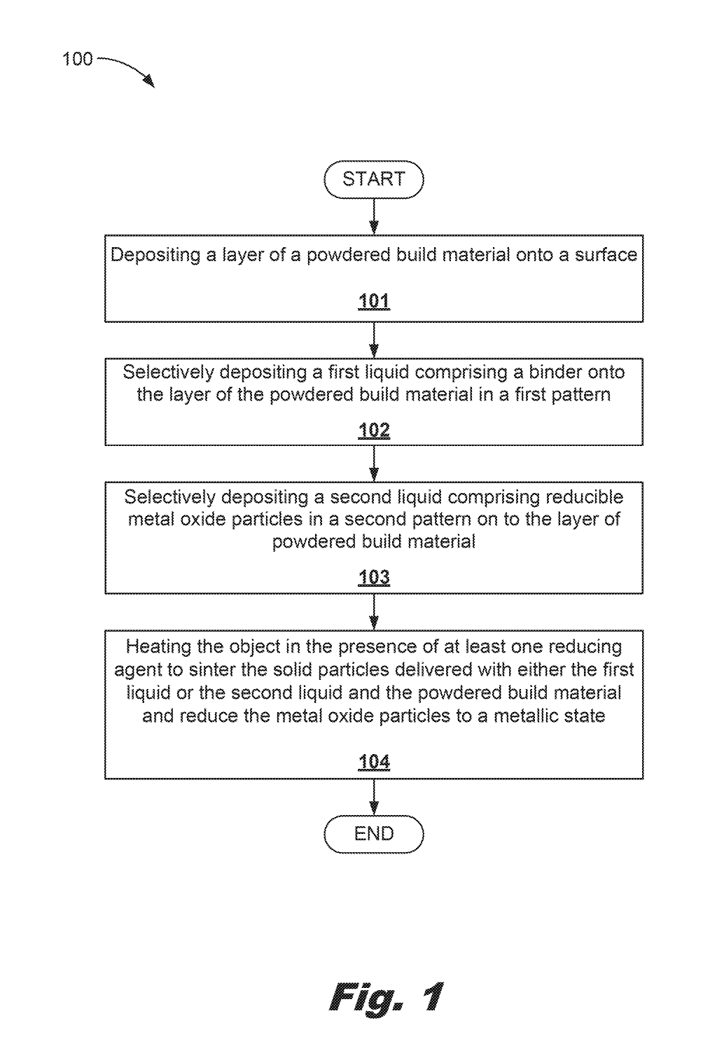

Turning now to the figures, FIG. 1 is a flowchart of a method for an additive manufacturing process to produce a 3D object that includes both metallic and non-metallic portions, consistent with the disclosed implementations. The method (100) includes depositing (101) a layer of a powdered build material onto a surface, selectively depositing (102) a first liquid that includes a binder onto the layer of the powdered build material in a first pattern, selectively depositing (103) a second liquid that includes reducible metal oxide particles in a second pattern onto the layer of powdered build material, heating (104) the object in the presence of at least one reducing agent to sinter the solid particles delivered with either the first liquid or the second liquid and the powdered build material and to reduce the metal oxide particles to a metallic state.

As mentioned above, the method (100) includes depositing (101) a layer of a powdered build material onto a surface. The surface onto which a layer of powdered build material is deposited includes any appropriate surface. This includes a surface within an additive manufacturing device or a layer that has previously been deposited in the formation of the object. A 3D object produced by the method (100) includes a number of layers. For example, the 3D object includes a single layer. In another example, the 3D object includes twenty-five layers. In a further example, the 3D object includes 5,000 layers or more.

Various types of build material may be deposited as a layer onto a surface. In one example, the build material is a fusible material. A fusible material fuses together at elevated temperatures to form a solid body. Non-limiting examples of fusible materials include polyamide 12, and materials with a glass transition temperature near the heating temperature used to reduce the metal oxide particles to their metallic state. In one example, silver oxide particles are used as the reducible metal oxide particles and polynorbornene, polysulfones, and combinations thereof are used as a fusible build material. In another example, copper (II) oxide particles are used as the reducible metal oxide particles, and aluminum oxide or silica is used as a fusible build material.

In another example, the build material is a ceramic material. Ceramics are inorganic solid materials. Non-limiting examples of suitable ceramic materials include oxides that include at least one of silicon, aluminum, beryllium, barium, cerium, chromium, hafnium, iron, magnesium, niobium, scandium, tantalum, tin, titanium, tungsten, vanadium, zirconium, and yttrium. Further non-limiting examples of suitable ceramic materials include nitrides that include at least one of aluminum, chromium, gallium, hafnium, boron, molybdenum, niobium, tantalum, titanium, tungsten, vanadium, zirconium, and silicon. Additional non-limiting examples of suitable ceramic materials include fluorides that include at least one of aluminum, lithium, magnesium, and calcium. Further non-limiting examples of suitable ceramic materials include carbides that include at least one of boron, hafnium, silicon, titanium, tungsten, and zirconium. Mixtures and combinations of the above may also be used. This is a representative list and is not exhaustive of all possible build materials; in principle, any build material capable of withstanding the temperatures used for reduction of metal oxide particles to their metallic state may be used.

In a further example, the build material is a dielectric material. A dielectric material is a material that is polarized when in an electric field and acts as an insulator. Non-limiting examples of suitable dielectric materials include aluminum oxide (Al₂O₃), diatomaceous earth, borosilicate, quartz, magnesia (MgO), zirconium silicate (ZrSiO₄), and combinations thereof.

In some examples, a build material that is capable of conducting electricity is used, either alone or in combination with another build material that acts as an insulator. Non-limiting examples of build materials that are capable of conducting electricity include tungsten carbide (WC), titanium boride (TiB₂), zirconium boride (ZrB₂), titanium nitride (TiN), zirconium nitride (ZrN), and combinations thereof. In one example, an electrically conductive build material is used as the build material for a non-electrical application. In another example, an electrically conductive build material is used in combination with an electrically insulating build material to enhance the electrical conductivity of the metallic portions of an object. In such an example, the combination involves depositing (101) a mixture of an electrically conductive build material and an electrically insulating build material. In another such example, the combination involves depositing (101) an electrically insulting build material to the portions of a layer onto which a first liquid will be selectively deposited (102), and an electrically conductive build material to the portions of a layer onto which a second liquid will be selectively deposited (103).

The classification of a build material as one type of material is not mutually exclusive with classification as another type of material. For example, aluminum oxide is both a ceramic material and a dielectric material.

In one example, a build material is provided as a powder. In another example, a build material is provided as a slurry. A suitable build material includes particles, which are preferably free flowing. Free flowing build material particles are any suitable size, such as from 1 micrometer (μm) to 500 μm. For example, a build material is provided as a powder with a particle size range from 1 μm to 500 μm, or from 10 μm to 500 μm. In another example, a build material is provided as a powder with a particle size ranging from 10 μm to 200 μm, such as from 10 μm to 100 μm. According to another example, a build material is provided as a slurry with particle sizes ranging from 10 nanometers (nm) to 10 μm.

An aspect ratio is determined for a particle of the build material. An aspect ratio is the ratio of the longest diameter of the particle to the shortest diameter of the particle that is orthogonal to the longest diameter of the particle. An aspect ratio close to 1 promotes the free flowing of the particles. In an example, a build material is provided as a powder with particles with aspect ratios ranging from 1 to 3, such as from 1 to 2. In another example, a build material is provided as a powder with particles with aspect ratios ranging from 1 to 2.5, such as from 1 to 1.5. In a further example, a build material has particles that are approximately spherical, having an aspect ratio from 1 to 1.2.

As mentioned above, the method (100) includes selectively depositing (102) a first liquid that includes a binder onto the layer of the powdered build material in a first pattern. The first liquid is selectively deposited (102) onto the layer of the powdered build material in the form of a first pattern. In some examples, there are portions of a layer of a powdered build material that were not included in either the first pattern or the second pattern, and thus have not come in contact with a liquid. Build material that has not come in contact with a liquid remains free flowing. When appropriate, build material that has not contacted a liquid may be retained to structurally support the object during heating. In another example, build material that has not come in contact with a liquid is removed prior to heating.

As mentioned above, the first liquid includes a binder. A binder is a component that promotes cohesion of the build material particles. A binder operates through any suitable mechanism, such as acting to transfer heat to the build material particles to cause the build material particles to fuse together. This type of binder is referred to as a susceptor. In another example, a binder facilitates the fusing of the larger build material particles together, as well as filling any spaces between the build material particles. This type of binder is referred to as a sintering aid. In some examples, a sintering aid is a solid particle. Some binders operate by more than one mechanism. Alternatively, a first liquid includes more than one binder to operate by more than one mechanism. For example, a first liquid includes both a susceptor and a sintering aid, and both the susceptor and the sintering aid are solid particles.

In an example, a binder includes a susceptor. A susceptor absorbs electromagnetic radiation, such as microwave radiation, and transfers that energy into heat. In some examples, a susceptor may be a solid particle. In some instances, the ability of a susceptor to absorb microwave energy depends on the temperature of the susceptor. Some susceptors absorb microwave radiation effectively at an ambient temperature of 20-25 degrees Celsius, while other susceptors absorb microwave radiation effectively at elevated temperatures. In an example, a susceptor that absorbs microwave radiation at or near ambient temperature is used by the method (100).

In another example, a binder includes small particles of an agent similar to, or the same as, the build material, which fills spaces between the build material particles; these may be referred to as a sintering aid, which is a type of binder. Upon heating, these particles are able to mediate the fusing together of the build material particles to sinter the object, and are sintered to and around the build material particles. In such an example, silica particles are used. Such small particles are smaller than the build material particles, and fill the spaces between the build material particles. Accordingly, in some examples, the binder particles are nanoparticles held in a stable dispersion in a first liquid. Providing a first liquid that is a stable dispersion may make the first liquid suitable for facile dispensing, such as by jetting.

Non-limiting examples of compounds which are used as binders in a first liquid include allotropes of carbon, silica, silicon carbide, an iron oxide, silica nanoparticles, aluminum oxide nanoparticles, and combinations thereof.

A binder, or a combination of binders, is present in a first liquid in an amount up to 50 percent by weight, relative to the total weight of the first liquid. For example, a first liquid according to the present specification includes from 10 percent to 45 percent by weight, such as from 20 percent to 40 percent by weight or from 30 percent to 40 percent by weight of at least one binder, with all weights being relative to the total weight of the composition. According to another example, at least one binder is included in a first liquid in the highest amount that the first liquid can support while remaining a stable dispersion of the binder, in order to most efficiently sinter the build material during heating.

According to one example, a first liquid may be dispensed by jetting, such as from an inkjet because of the precision with which inkjets can dispense agents and their flexibility to dispense different types and formulations of liquids. In such an example, the first liquid, and the binder included therein, are provided to be suitable for such deposition methods. For example, the first liquid is able to sustain increased pressure without perturbing the stability of the dispersion; such pressure is achieved by a piezoelectric apparatus, by increased temperature of the ink, or by any other suitable method.

As mentioned above, the method (100) includes selectively depositing (103) a second liquid that includes reducible metal oxide particles in a second pattern onto the layer of powdered build material. The second liquid that is selectively deposited (103) includes reducible metal oxide particles, the liquid is deposited onto the layer of the powdered build material in the form of a second pattern. Once the layer is formed, the next step is determined by whether the object is now fully formed. If the object is not fully formed, another layer is deposited. In some examples, there are portions of a layer of a powdered build material that were not included in either the first pattern or the second pattern, and thus have not come in contact with a liquid. Build material that has not come in contact with a liquid remains free flowing. When appropriate, build material that has not contacted a liquid is retained to structurally support the object during heating. In some examples, build material that has not come in contact with a liquid is removed prior to heating.

As mentioned above, the second liquid includes reducible metal oxide particles. The second liquid holds the reducible metal oxide particles in a stable dispersion, so that the selective deposition of the second liquid deposits reducible metal oxide particles onto the layer of a build material. The second liquid may include additional components, such as a fluid portion to hold the reducible metal oxide particles in a stable dispersion, a binder, a suspension aid, or any other suitable components.

Reducible metal oxide particles are selected for incorporation into the second liquid so that they are reduced at elevated temperatures in the presence of a reducing agent. Non-limiting examples of suitable reducible metal oxide particles include copper(II) oxide (CuO), silver oxide (Ag₂O), gold oxide (Au₂O₃), iron(II) oxide (FeO), iron(III) oxide (Fe₂O₃), iron(II,III) oxide (Fe₃O₄), nickel(II) oxide (NiO), manganese(IV) dioxide (MnO₂), cobalt oxides (CoO, CO₃O₄, and combinations thereof), zinc oxide (ZnO), chromium oxide, tin(IV) oxide (SnO₂), and combinations thereof. According to an example, a reducible metal oxide particle is selected to be reduced upon heating in the presence of a reducing agent.

In some examples, a reducible metal oxide is a susceptor. That is, the reducible metal oxide is capable of acting to absorb radiation. Such a reducible metal oxide may absorb electromagnetic radiation and converts the energy into heat. In other examples, a reducible metal oxide is not a susceptor, or is not an efficient susceptor. A reducible metal oxide particle may be a solid particle.

In one example, a reducible metal oxide particle is incorporated into a second liquid as a stable dispersion. Such a stable dispersion is achieved by providing reducible metal oxide particles that are sufficiently small, such as, for example, 100 nanometers (nm) or less in diameter. In another example, a second liquid includes reducible metal oxide particles that are 60 nm or less, such as 50 nm or less, or 40 nm or less in diameter.

In an example, the second fluid is dispensed by jetting, such as from an inkjet. In such an example, the second composition is a stable dispersion that remains a dispersion during deposition onto the layer of build material by jetting.

A first liquid and a second liquid may contain solid particles; such solid particles remain when the liquid phase evaporates. The solid particles in a first or second liquid may be said to be delivered with the first or second liquid. Such solid particles may include a susceptor, a sintering aid, a binder, a reducible metal oxide particle, or any other component of the first or second liquid that is a solid, and may be held in a stable dispersion in the first or second liquid. In some examples, the solid particles delivered with the first or second liquid include a sintering aid, and heating (104) may sinter the build material and the solid particles delivered with the first or second liquid.

As mentioned above, the method (100) includes heating (104) the object in the presence of at least one reducing agent to sinter the binder and the powdered build material. When the object has been formed in a layer-wise fashion, the object is heated (104) in the presence of at least one reducing agent. Heating (104) the object acts to sinter the binder and the powdered build material. Heating (104) in the presence of at least one reducing agent also acts to reduce the metal oxide particles to their metallic state.

Heating (104) may be performed by any suitable method. In one example, heating (104) is performed by electromagnetic radiation, such as microwave radiation, radio frequency radiation, visible light radiation, ultraviolet radiation, or the like. In another example, heating (104) is performed by thermal energy, such as the use of an electric or gas furnace which heats the object by heating the environment surrounding the object.

Following the selective deposition (102) of a first liquid onto the layer of powdered build material and the selective deposition (103) of a second liquid onto the layer of powdered build material, the object is either heated (104) in the presence of a reducing agent or another layer is deposited. An object is heated (104) to fully or partially sinter the object, or to reduce the metal oxides to their metallic state. Sintering is the binding of particles together at temperatures near, but below, their melting temperature, to solidify and harden a 3D object. An object may be heated (104) prior to addition of further layers onto the object, or an object may be heated (104) after a number of layers have been deposited. In one example, an object is heated (104) after each layer is deposited. In another example, an object is heated (104) in the presence of a reducing agent after any layer that included selective deposition (103) of the second fluid. In a further example, an object is heated (104) after the object is fully formed.

Heating (104) is performed in the presence of a reducing agent. In one example, a reducing agent is provided in solid form, as part of the stable dispersion of either the first liquid or the second liquid. In a second example, a reducing agent is provided externally, such as by hydrogen gas that is present during heating (104). In another example, a reducing agent may be provided in both solid form and externally, such as by including carbon black and heating (104) in the presence of hydrogen gas. Non-limiting examples of suitable reducing agents include hydrogen gas, carbon monoxide gas, hydrazine, carbon black, coke, carbides, other sources of carbon, metals in their metallic state, and combinations thereof. In other examples, volatile organic compounds may also be used as reducing agents. The use of hydrogen gas as a reducing agent produces water. The use of carbon monoxide gas as a reducing agent produces carbon dioxide. The use of carbon black, coke, or other sources of carbon as a reducing agent produces carbon monoxide and/or carbon dioxide. Metals in their metallic state may be used as a reducing agent if the oxide of the metal being used as a reducing agent is more stable than the reducible metal oxide being reduced to its metallic state. For example, magnesium oxide is more stable than copper(II) oxide, and so metallic magnesium used to reduce copper(II) oxide to metallic copper according to the reaction CuO+Mg→Cu+MgO. In some examples, it is suitable to use a reducing agent that is removed from the object during the reduction of the metal oxide to its metallic state, such as hydrogen or carbon sources. It may be suitable to use more than one reducing agent, which can be provided both in a first liquid and externally during heating (104).

Heating (104) the object in the presence of at least one reducing agent acts to reduce the metal oxide particles to their metallic state.

In the method (100), it is possible to form each layer individually and subject the individual layer to heat to solidify the layer and then heat the final product to sinter a number of layers together. Alternatively, it is possible to prepare a number of layers together, subject the group of layers to heat to solidify the group of layers and then heat the final product to sinter layers together. This type of assembly advantageous if the object is especially large, or to provide efficient contact between a second fluid and at least one reducing agent during heating. It is also possible to prepare the 3D object as a green body, and heat (104) the 3D object in the presence of at least one reducing agent once.

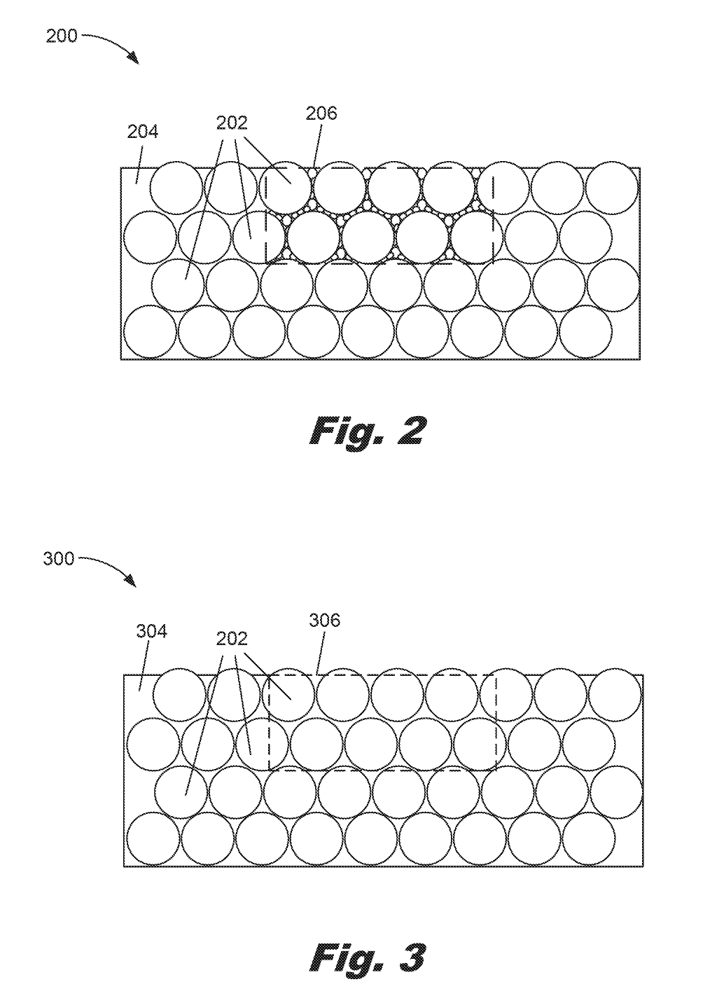

FIG. 2 shows a diagram of integration of metallic and non-metallic portions into an object produced by an additive manufacturing process, shown prior to sintering, consistent with the disclosed implementations. Specifically, FIG. 2 illustrates a diagram of an interface between metallic and non-metallic portions of a green body.

As illustrated in FIG. 2, the object (200) includes a build material (202). The build material (202) is illustrated as large circles in FIG. 2. The build material (202) is surrounded by either a first liquid (204) that includes a binder or a second liquid (206) that includes reducible metal oxide particles. The reducible metal oxide particles of the second liquid (206) are illustrated as small circles that fill the spaces between the build material (202). In FIG. 2, the first liquid (204) flows to the edges of the object (200). In other examples, the first liquid (204) is selectively deposited such that a portion of build material (202) surrounds the outer edges and a portion of the build material (202) does not receive either the first liquid (204) or the second liquid (206).

The object (200) includes either two or four layers. In an example, a layer has a thickness that corresponds to a single particle of build material (202). In another example, a layer has a thickness that corresponds to multiple particles of build material (202).

While FIG. 2 illustrates the build material (202) in a hexagonal packing, other packings can be present. The packing of the particles of the build material (202) is a function of the shape of the particles.

FIG. 3 is a diagram of the object of FIG. 2, shown after sintering, consistent with the disclosed implementations. Specifically, FIG. 3 illustrates the build material (202) after sintering, surrounded by either the sintered first liquid (304) or the sintered second liquid (306).

FIG. 3 illustrates the sintered first liquid (304) as providing a solid edge. The solid edge is achieved when the first liquid (202) includes a sintering aid.

The object (300) of FIG. 3 illustrates the sintered second liquid (306). The sintered second liquid (306) fills the space between build material (202) particles in the region to which the second liquid (206) was deposited. The region is indicated by the dashed lines in FIG. 3. The sintered second liquid (306) includes a metal in its metallic state. In some examples, the metal in its metallic state in the sintered second liquid (306) is capable of conducting electricity. While FIG. 3 illustrates a small space between particles of the build material (202), when expanded to three-dimensions, the sintered second liquid (306) includes an uninterrupted path through which electrical current may travel.

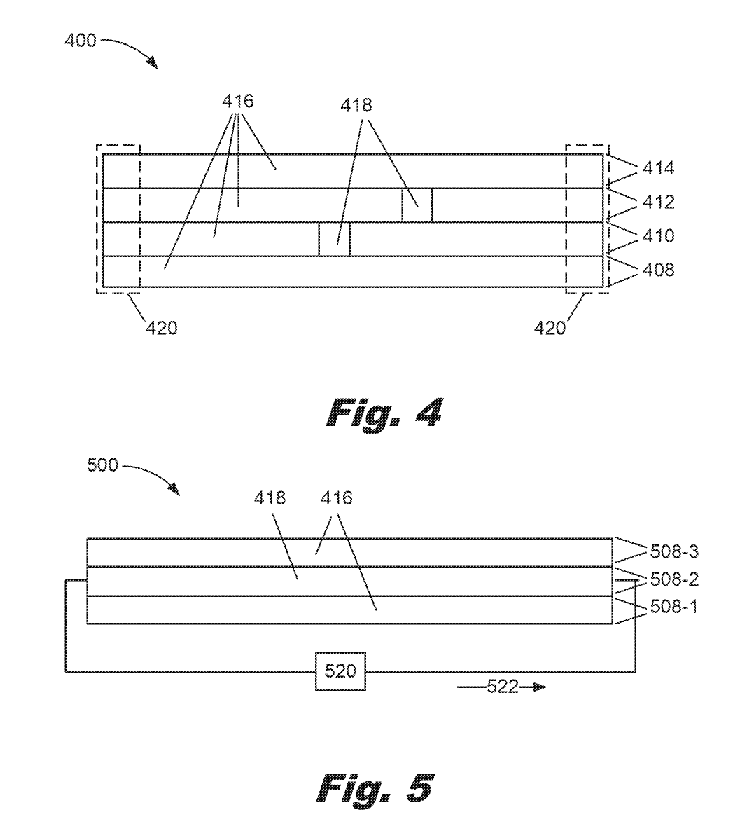

FIG. 4 is a cross-sectional diagram of an object produced by an additive manufacturing device, consistent with the disclosed implementations. As will be described below, the cross-sectional diagram of the object includes a number of layers with metallic and non-metallic regions.

The cross-sectional diagram of the object (400) of FIG. 4 includes four layers (408, 410, 412, and 414). Each layer (408, 410, 412, and 414) includes a free flowing region (420) onto which neither the first liquid (204) nor the second liquid (206) was dispensed. Accordingly, the build material (202) held within the free flowing region (420) remains free flowing. The build material (202) in the free flowing region (420) may be retained to provide structural support during sintering or may be removed prior to sintering.

The portion of the first layer (408) onto which the first liquid (204) was dispensed provides a non-metallic region (416). Each layer (408, 410, 412, and 414) includes a non-metallic region (416) onto which the first liquid (204) was dispensed.

The second layer (410) and the third layer (412), both include a metallic region (418) onto which the second liquid (206) was dispensed. The metallic region (418) includes reducible metal oxides prior to sintering and metal in its metallic state after sintering. In some examples, the metallic region (418) is capable of conducting electricity. In one example, the metallic region (418) goes to the edge of the object (400), while in other examples, the metallic region (418) is completely included within the object (400).

FIG. 5 is a cross-sectional diagram of an object produced by an additive manufacturing device conducting an electrical current, consistent with the disclosed implementations. As will be described below, the object includes a number of layers.

The cross-sectional diagram shown in FIG. 5 includes an object (500) that includes three layers (508). The first layer (508-1) and the third layer (508-3) include a non-metallic region (416). The second layer (508-2) includes a metallic region (418). The metal within metallic region (418) illustrated in FIG. 5 provides a continuous metallic pattern, and is capable of conducting electricity.

FIG. 5 illustrates other circuitry elements (520). The other circuitry elements (520) include a power source, which may be anything that provides an electrical potential difference, such as a battery, a capacitor, or the like.

FIG. 5 further illustrates an electrical current that passes through the metallic region (418) of the object (500) in the direction indicated by arrow 522. In an example, the electrical current is produced by the circuitry elements (520). As a result, electrical current flows through the object (500).

As illustrated in FIG. 3, a metallic region (418) is not exclusively metal, but also include a build material (202). A build material (202) may provide a significant portion of the cross-sectional area of the metallic region (418). Accordingly, the resistivity of a metallic region (418) is determined by including the build material (202) as providing a portion of the cross-sectional area. Thus, in some examples, an electrical current travels through the metal included within the metallic region (418). In some examples, the metal within a metallic region (418) may include a continuous metallic pattern, so as to be capable of conducting electricity. The inclusion of the build material (202) in determining the resistivity may appear to artificially inflate the resistivity of the metallic region (418), relative to the resistivity of the metal included within a continuous metallic pattern within the metallic region (418).

However, by including the build material (202) in the determination of the resistivity of the metallic region (418), the resistivity is determined directly by calculation from the resistance of the metallic region (418) and the geometry of the metallic region (418). This is done without a correction factor relating to the density of the metal within the metallic region (418) or the completeness of the reduction of the metal oxide to its metallic state during sintering. Additionally, if the build material (202) is capable of conducting electricity is used, either alone or in combination with an insulating build material (202), the resistivity of the metallic region (418) corresponds to the bulk resistivity of the metallic region (418).

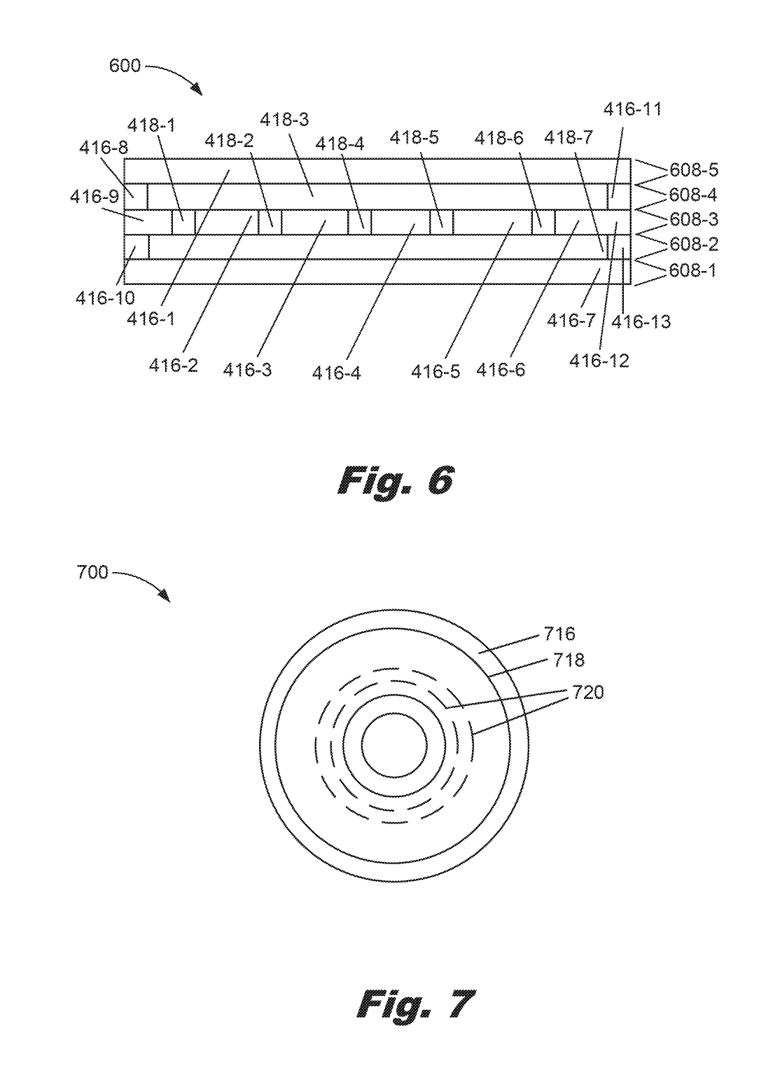

FIG. 6 is a cross-sectional diagram of an object produced by an additive manufacturing device with increased fracture toughness due to a metallic pattern within the object, consistent with the disclosed implementations. As will be described below the object includes a number of layers with metallic regions and non-metallic regions.

As illustrated, the object (600) includes a number of layers (608). For example, the object (600) includes a first layer (608-1), a second layer (608-2), a third layer (608-3), a fourth layer (608-4), and a fifth layer (608-5). Some of the layers (608) include both metallic regions (418) and non-metallic regions (416). The non-metallic region is located on the outer surface of the object (600).

In the cross-sectional diagram of FIG. 6, the metallic regions (418) are arranged to provide a mesh through the object (600). Such a mesh is provided in order to increase the fracture toughness of the object (600) in any direction. Alternatively, the metallic regions (418) are arranged within the object (600) to strengthen the weakest regions of the object (600) that are most likely to crack. A region that is most likely to crack is the most likely location for a crack to propagate into a fracture.

According to one example, a number of metallic regions (418) are arranged within the object (600) to fill the inner portion of the object (600) and provide increased fracture toughness in any direction. In another example, the metallic regions (418) are arranged within the object (600) to provide a number of discrete metallic supports within the object (600).

A metallic support within the object (600) is obtained by forming a continuous metallic film through and around a build material (202). A continuous metallic film is formed upon reduction of a number of reducible metal oxide particles to their metallic state. A continuous metallic film may be local, or may also be extended within an object.

FIG. 7 is a diagram of an object produced by additive manufacturing with increased fracture toughness due to a metallic pattern within the object, consistent with the disclosed implementations. As will be described below, the object is a disc with non-metallic portions and metallic portions.

The object (700) of FIG. 7 is a disc. The object (700) includes non-metallic portions (716). On the interior of the object (700) are several metallic regions (718, 720), arranged in different patterns. The metallic regions (718, 720) act to increase the fracture toughness of the object (700). The filled metallic region (718) provides structural reinforcement through the circumference of the object (700). The segmented metallic regions (720) provide structural reinforcement through segments of the object (700). The segmented metallic regions (720) are arranged to provide structural reinforcement along any diameter of the object (700).

While FIG. 7 describes the object (700) as a disc, the same principles presented in FIG. 7 may be applied to an object of any shape. In one example, an object includes filled metallic regions (718) in any suitable number or placement within the object. In another example, an object includes segmented metallic regions (720) in any suitable number or placement within the object. In a further example, segmented metallic regions (720) are used in combination with filled metallic regions (718).

The metallic regions (718, 720) act to increase the fracture toughness of the object (700) may be provided in any suitable arrangement. In one example, metallic regions are arranged concentrically in the shape of the object and within the object. In another example, metallic regions are localized to a specific part of an object. In a further example, metallic regions branch out radially from a point within the object. Other arrangements are also suitable, according to the types of stress an object is likely to experience.

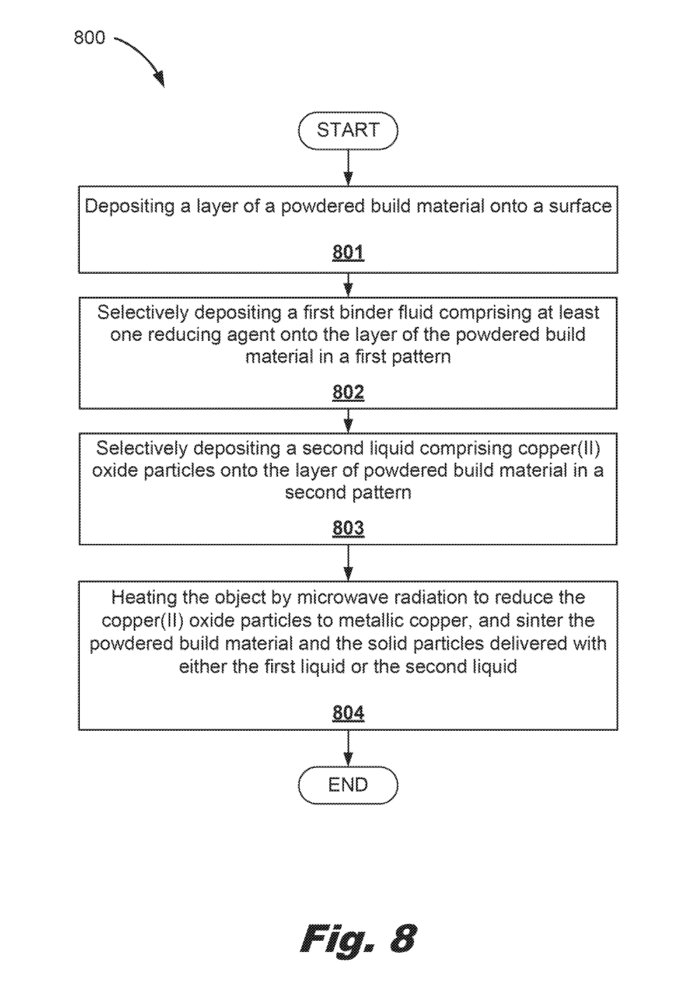

FIG. 8 is a flowchart of a method for an additive manufacturing process to produce an object that includes both metallic and non-metallic portions in a layer-wise fashion, consistent with the disclosed implementations. The method (800) includes forming a 3D object by depositing (801) a layer of a powdered build material onto a surface, selectively depositing (802) a first binder fluid that includes at least one reducing agent onto the layer of powdered build material in a first pattern, selectively depositing (803) a second binder fluid that includes copper(II) oxide particles onto the layer of powdered build material in a second pattern, heating (804) the object by microwave radiation to reduce the copper(II) oxide particles to metallic copper and to sinter the powdered build material and the solid particles delivered with either the first liquid or the second liquid.

A first binder fluid that is selectively deposited (803) according to the method shown in FIG. 8 includes a binder. A binder may be as provided above, and may include either a sintering aid, a susceptor, or combinations thereof. A first binder fluid that is selectively deposited (802) according to the method (800) includes at least one reducing agent. A reducing agent is provided by the first binder fluid in order to provide reducing equivalents to reduce a metal oxide to its metallic state. According to one example, selectively depositing (802) a first binder fluid that includes a reducing agent is advantageous by providing interior regions to which the second binder fluid is deposited effective access to a reducing agent that may be more difficult to achieve if the reducing agent were provided externally to the object. In one example, a reducing agent is chosen for inclusion in the first binder fluid so as to preserve the structural integrity of the object. In another example, a reducing agent is chosen for inclusion in the first binder fluid to be removed by evaporation upon heating to a temperature. Non-limiting examples of suitable reducing agents include carbon black, coke, carbohydrates such as sugars, and other sources of carbon, metals in their metallic state, and combinations thereof.

A reducing agent that is present in a first binder fluid may, in some examples, be supplemented by a reducing agent that is provided externally, such as by hydrogen gas, alone or in combination with carbon monoxide that is present during heating (804).

A second binder fluid that is selectively deposited (803) may include a binder. A second binder fluid that is selectively deposited (803) also includes a reducible metal oxide particle. In some examples, the binder of the second binder fluid may be a reducible metal oxide, as heating in a reducing environment to reduce the metal oxide particle to its metallic state may form a metallic pattern around the build material, which thus acts as a sintering aid. In the example, the reducible metal oxide particle used is a copper(II) oxide particle.

After the first binder fluid has been selectively deposited (802) and the second binder fluid has been selectively deposited (803), another layer may be added by depositing a layer of powdered build material, followed by selective deposition of a first and second binder fluid. Once the final layer has been deposited, the object is heated (804) by microwave radiation. Microwave radiation interacts with a susceptor within the object to heat the object; such a susceptor is included in the first binder fluid, the second binder fluid, the powdered build material, or combinations thereof. Heating (804) reduces the copper(II) oxide particles to metallic copper and sinters the build materials and the solid particles delivered with either the first liquid or the second liquid.

A method (800) may apply heat between deposition of layers. The application of heat between depositing a layer and depositing the next layer may fully or partially sinter the build material and the solid particles delivered with either the first liquid or the second liquid, and may also fully or partially reduce the metal oxide particles to their metallic state.

FIG. 9 is a diagram of an additive manufacturing device for forming a 3D object with a metal disposed therein by applying layers of build material and liquids, consistent with the disclosed implementations. As will be described below, the additive manufacturing device includes a number of components.

The additive manufacturing device includes a chamber (924) in which the 3D object is formed. The chamber (924) includes a surface (926) onto which a first layer of build material (202) is deposited to form the 3D object.

The additive manufacturing device (900) includes a powdered build material dispenser (928). The powdered build material dispenser (928) dispenses layers of a powdered build material into the chamber (924), which may be applied evenly onto a surface (926) or onto a layer of an object.

The additive manufacturing device (900) includes a first liquid dispenser (930). The first liquid dispenser (930) dispenses a first liquid.

The additive manufacturing device (900) includes a second liquid dispenser (932). The second liquid dispenser (932) dispenses a second liquid.

The powdered build material dispenser (928), first liquid dispenser (930), and second liquid dispenser (932) are equipped with a movement mechanism (934). The movement mechanism (934) moves the dispensers (928, 930, and 932) to the appropriate location within the chamber (924) when forming the 3D object.

In some examples, the surface (926) moves such that the movement mechanisms (934) move the dispensers (928, 930, and 932) in two dimensions such as a lateral and a longitudinal dimension. In other examples, the surface (926) is stationary and the movement mechanisms (934) are configured to move the dispensers (928, 930, 932) in three dimensions such as a lateral, a longitudinal and a vertical dimension.

While three distinct dispensers (928, 930, and 932) are illustrated, two or more of the dispensers can be integrated into a single device. For example, using different printheads (or groups of printheads) in a single inkjet printhead assembly.

The additive manufacturing device (900) includes a heating element (936). The heating element (936) operates through any suitable mechanism, such as production of light or electromagnetic radiation, such as microwaves, which produce heat upon contact with a number of layers. The heating element (936) may also generate heat directly, whereby heating the object by radiant heat.

An additive manufacturing device (900) may also include additional elements, such as a flattening element. A flattening element flattens a layer of a powdered build material to ensure that the layer is evenly deposited across the surface (926).

While FIG. 9 illustrates one of each of a build material dispenser (928), a first liquid dispenser (930), a second liquid dispenser (932) and a heating element (936), it is possible to have multiple of any or all of these elements. For example, an additive manufacturing device may include a radiant heating element to drive evaporation of a liquid when a powdered build material is deposited as a slurry as well as a microwave heating element to drive sintering and reduction of a metal oxide to its metallic state. In another example, an additive manufacturing device includes at least two of at least one dispenser (928, 930, and 932). In another example, movement mechanisms (934) are provided to move the dispensers (928, 930, and 932) in one dimension, while moving the surface (926) in two dimensions. In a yet another example, a movement mechanism is provided to move the surface (926) in three dimensions, while the dispensers (928, 930, and 932) remain stationary. Combinations of the above examples are also possible in accordance with the present specification.

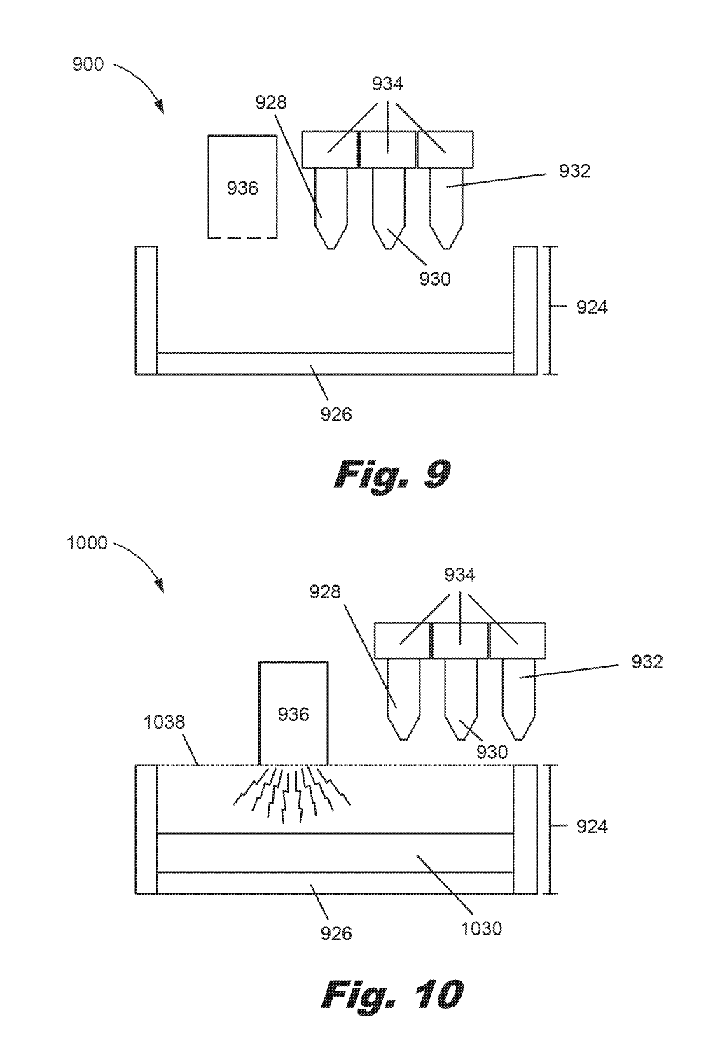

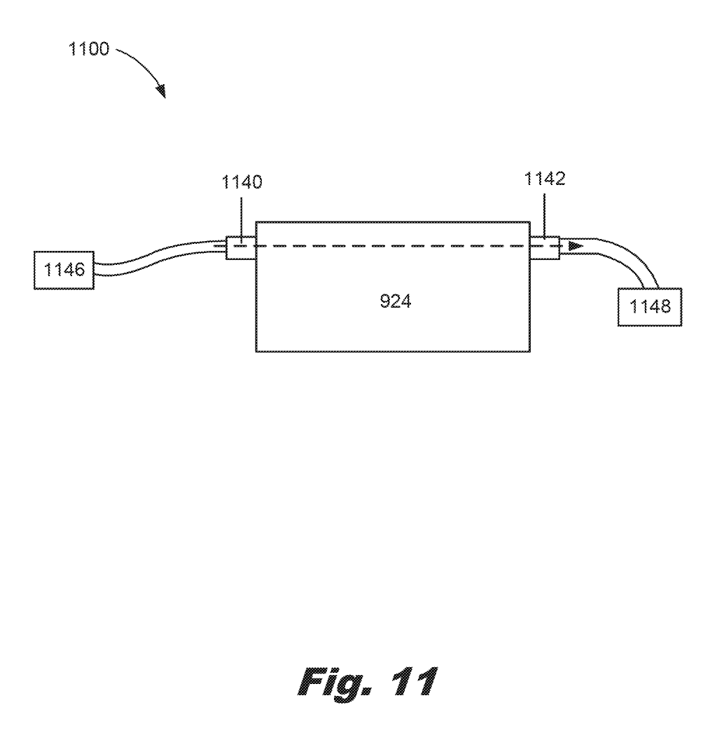

FIG. 10 is a diagram of an additive manufacturing device for forming a 3D object with a metal disposed therein heating an object included within the chamber, consistent with the disclosed implementations.

The additive manufacturing device (1000) of FIG. 10 is similar to the additive manufacturing device (900) of FIG. 9. The heating element (936) of FIG. 10 is positioned over the object (1040) on the surface (926). In an example, the movement mechanisms (934) have moved the powdered build material dispenser (928), the first liquid dispenser (930) and the second liquid dispenser (932) so that the materials not yet dispensed are unaffected by heating. In an example, the additive manufacturing device (1000) includes an enclosing element (1038) to enclose the object (1040) while the heating element (936) is operating. In one example, the heating element (936) operates by emitting microwave radiation and the enclosing element (1038) shields the first liquid dispenser (930) and the second liquid dispenser (932) from the microwave radiation.

FIG. 11 is a diagram of an internal environmental control mechanism for an additive manufacturing device, consistent with the disclosed implementations. As will be described below, the diagram includes a chamber, a gas inlet valve and a gas outlet valve.

As illustrated, the diagram (1100) includes a chamber (924) that is equipped with a gas inlet valve (1140), and a gas outlet valve (1142). Gas flows into the chamber (924) through the inlet valve (1140) and exits the chamber (924) through the outlet valve (1142), along the path illustrated by the dashed arrow.

The gas is provided to the inlet valve (1140) by a gas source (1146). The gas is either a pure gas or a mixture of gases. In one example, the gas source (1146) provides hydrogen gas to act as a reducing agent during heating. In another example, the gas source (1146) provides hydrogen and carbon monoxide to act as reducing agents during heating. In another example, the gas source (1146) provides a mixture of hydrogen gas and an unreactive carrier gas, such as nitrogen, argon, or helium. In another example, the gas source (1146) provides an unreactive gas, such as nitrogen, and a reducing agent is provided from a solid or liquid source within an object.

The gas that exits through the outlet valve (1142) exits through a vent (1148). In an example, the vent (1148) vents the gas expelled from the chamber (924) through a fume hood.

### EXAMPLES

### Example 1

Aluminum oxide (Al₂O₃) powder with a particle size of approximately 18 micrometers (μm) (“AA-18” from Sumitomo Chemical, headquartered in Tokyo, Japan) was used as the build material. Three liquids were used for patterning of successive layers of the build material. The first liquid included a susceptor, the second liquid included a sintering aid as a binder; the third liquid included copper(II) oxide particles.

The first liquid included 8 percent by weight of carbon black particles, with a particle size of approximately 100 nanometers (nm) (“Cab-O-Jet 300” carbon black dispersion from Cabot Corporation, headquartered in Boston, Mass.). The first liquid also included Surfynol® 465, which is an ethoxylated acetylenic diol wetting agent available from Air Products, headquartered in Allentown, Pa. The formulation of the first liquid is provided in Table I, below.

TABLE I

| | Active | Percent in |
|---|---|---|
| First Liquid | Material | Formulation |
| 1-(2-hydroxyethyl)-2-pyrrolidone (HE-2P) | 100.00% | 21.00% |
| Cab-O-Jet 300 Carbon Black Dispersion | 15.00% | 53.33% |
| Surfynol ® 465 | 100.00% | 0.40% |
| Water | 100.00% | 25.27% |
| Total | | 100% |

The second liquid included 20 percent by weight of silica (SiO₂) nanoparticles, with a particle size of approximately 30 nm (“SNOWTEX® ST-30 LH” from Nissan Chemical, headquartered in Tokyo, Japan). The second liquid also included SILQUEST® A-1230, which is a silane wetting agent available from Momentive Performance Materials, headquartered in Waterford, N.Y. The second liquid also included the same Surfynol® 465 as in the first liquid. The second liquid also included PROXEL® GXL Biocide, which is a dispersion of 1,2-benzisothiazolin-3-one in water and dipropylene glycol available from Excel Industries, Ltd., headquartered in Mumbai, India. The formulation of the second liquid is provided in Table II, below.

TABLE II

| | Percent in |
|---|---|
| Second Liquid | Formulation |
| SNOWTEX ® ST-30 LH, per dry material | 20.00% |
| 2-Pyrrolidone (co-solvent) | 17.00% |
| SILQUEST ® A-1230 (co-solvent) | 5.00% |
| Surfynol ® 465 (surfactant) | 0.20% |
| PROXEL ® GXL Biocide | 0.05% |
| Water | 57.75% |
| Total | 100% |

The third liquid included approximately 15% by weight of copper(II) oxide particles, with an approximate particle size of 40 nm, prepared by bead-milling of CuO powder purchased from Sigma-Aldrich, headquartered in Saint Louis, Mo. Bead-milling was performed in an aqueous environment using citric acid (10.00% by weight, relative to the weight of CuO) and SILQUEST® A-1230 (15% by weight, relative to the weight of CuO). The formulation of the third liquid is provided in Table III, below.

TABLE III

| | Active | Percent in |
|---|---|---|
| Third Liquid | Material | Formulation |
| 1-(2-hydroxyethyl)-2-pyrrolidone | 100.00% | 20.00% |
| CuO (40 nm) Dispersion | 20.78% | 72.18% |
| Surfynol ® 465 | 100.00% | 0.40% |
| Water | 100.00% | 7.42% |
| Total | | 100% |

A first layer of build material was deposited onto a surface. The first liquid was deposited onto the first layer of build material at an ink flux density of approximately 26 grams per square meter (g/m²). Then, the second liquid was deposited onto the first layer of build material at an ink flux density of approximately 39 g/m². Both the first and second liquids were jetted onto the build material from 600-1200 dots per inch (DPI). A second layer of build material was deposited onto the second layer. The second layer received equal parts of the first liquid and the third liquid, with an ink flux density of approximately 26 g/m² for each liquid. The jetting of all liquids was performed from an HP 792 printhead having a drop weight of 12 nanograms (ng). A third and fourth layer with the same composition as the second layer were added on top of the second layer. A fifth layer with the same composition as the first layer was added on top of the fourth layer.

Microwave heat was applied and the object was heated to 1180 degrees Celsius in a reducing atmosphere that included 5% hydrogen (H₂) as a reducing agent, and 95 percent nitrogen (N₂) as the carrier gas. Carbon black in the first liquid provided an additional reducing agent. Thus, the reducing agents included both hydrogen gas and carbon black. The copper(II) oxide was reduced to metallic copper during heating.

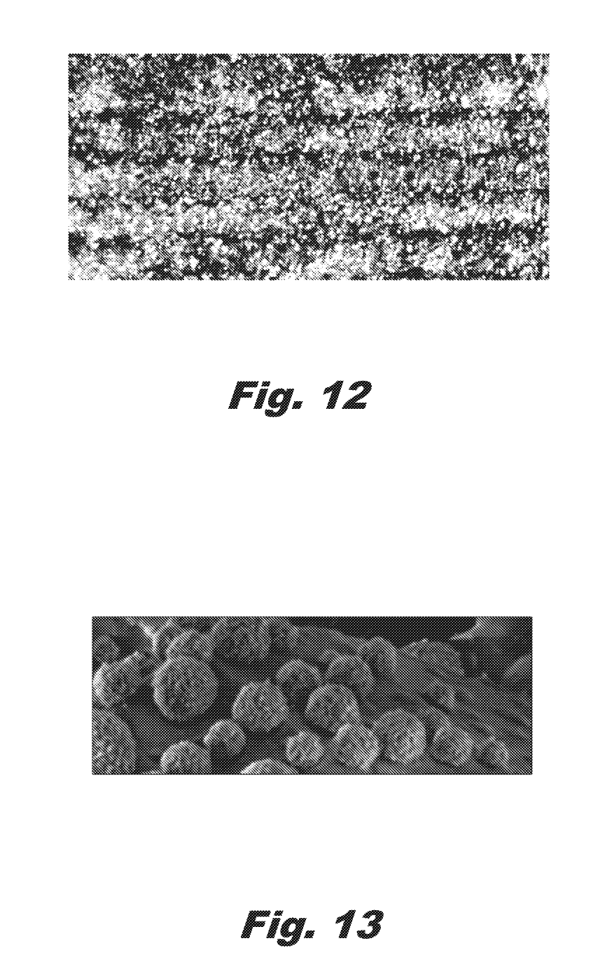

A cross section of the object produced in example 1 is shown in FIG. 12. Each layer has a thickness of approximately 102-105 micrometers (μm). The second layer has a thickness of 105.42 μm. The third layer has a thickness of 102.16 μm. The fourth layer has a thickness of 103.24 μm.

FIG. 13 shows a scanning electron microscope view of the object produced in example 1. The large particle is the aluminum oxide build material. The small beads on the build material are metallic copper. In one example, further coverage of the build material by the metallic copper is achieved using a higher loading of copper(II) oxide in the preparation of the object.

The object produced by the above example is capable of conducting electricity. A 3.5 millimeter long segment of the object measured a resistance of approximately 30 kiloOhms (kΩ), corresponding to a resistivity of approximately 0.86 Ohm-meters (Ω·m).

### Example 2

An object was prepared as in example 1, but heated to 515 degrees Celsius. The object did not have a measurable resistance, and thus was unable to conduct an electrical current.

While the present disclosure has provided a number of examples, it is contemplated that the devices and methods disclosed herein prove useful in addressing other matters and deficiencies in a number of technical areas. Therefore, the devices and methods disclosed herein should not be construed as addressing any of the particular matters.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for additive manufacturing, comprising:
forming a three-dimensional (3D) object by:
depositing a layer of a powdered build material onto a surface;
selectively depositing a first liquid comprising a binder onto the layer of the powdered build material in a first pattern;
selectively depositing a second liquid comprising reducible metal oxide particles in a second pattern onto the layer of powdered build material; and
heating the 3D object in the presence of at least one reducing agent to:
sinter the powdered build material; and
reduce the metal oxide particles to a metallic state.

2. The method of claim 1, wherein heating the object comprises using electromagnetic radiation to heat the object.

3. The method of claim 1, wherein heating the object comprises using thermal energy to heat the object.

4. The method of claim 1, wherein the powdered build material comprises a compound selected from:
a. oxides comprising at least one of silicon, aluminum, beryllium, barium, cerium, chromium, hafnium, iron, magnesium, niobium, scandium, tantalum, tin, titanium, tungsten, vanadium, zirconium, and yttrium;
b. nitrides comprising at least one of aluminum, chromium, gallium, hafnium, boron, molybdenum, niobium, tantalum, titanium, tungsten, vanadium, zirconium, and silicon;
c. fluorides comprising at least one of aluminum, lithium, magnesium, and calcium;
d. carbides comprising at least one of boron, hafnium, silicon, titanium, tungsten, and zirconium;
e. combinations thereof.

5. The method of claim 1, wherein the binder comprises one of an allotrope of carbon, aluminum oxide nanoparticles and silica nanoparticles.

6. The method of claim 1, wherein the first liquid comprises the at least one reducing agent, the reducing agent comprising one of carbon black, activated carbon, coke, and carbohydrates.

7. The method of claim 1, wherein the at least one reducing agent comprises a gas selected from hydrogen and carbon monoxide.

8. The method of claim 1, wherein the reducible metal oxide particles comprise one of: copper oxide, silver oxide, nickel oxide, cobalt oxide, gold oxide, iron oxide, zinc oxide, chromium oxide, and manganese dioxide.

9. The method of claim 1, wherein reducing the metal oxide particles produces a continuous metallic pattern that can conduct electricity, and has a resistivity ranging from 1.0×10⁻⁶ Ohm-meters (Ω·m) to 1.0 Ω·m.

10. The method of claim 1, wherein the second liquid is selectively deposited so that reduction of the metal oxide particles to a metallic state forms a continuous metallic film that increases the fracture toughness of the object.

11. An additive manufacturing method for preparing a three-dimensional (3D) object that comprises metal within an interior, comprising:
forming the 3D object by:
depositing a layer of a powdered build material onto a surface;
selectively depositing a first binder fluid comprising at least one reducing agent onto the layer of powdered build material in a first pattern;
selectively depositing a second binder fluid comprising copper(II) oxide particles onto the layer of powdered build material in a second pattern; and
heating the object by microwave radiation to:
reduce the copper(II) oxide particles to metallic copper; and
sinter the powdered build material and a sintering aid delivered with either the first liquid or the second liquid;
wherein the metallic copper disposed within the object is capable of conducting electricity with a resistivity ranging from 1.0×10⁻⁸ Ohm-meters (Ω·m) to 1.0 Ω·m.

12. The method of claim 11, wherein heating the object by microwave radiation comprises heating the object such that at least a part of the object reaches a temperature of at least 850° Celsius.

13. An additive manufacturing device for forming a three-dimensional (3D) object with a metal disposed therein, comprising:
a chamber comprising a surface on which a 3D object is formed;
a number of powdered build material dispensers to dispense layers of a powdered build material into the chamber;
a number of liquid dispensers to dispense at least two liquids into the chamber, comprising:
a first liquid comprising a binder; and
a second liquid which comprises reducible metal oxide particles; and
a number of heating elements to:
sinter the binder and the powdered build material; and
reduce at least one metal oxide particle to a metallic state.

14. The additive manufacturing device of claim 13, wherein the number of heating elements heat the object by emitting microwave radiation.

15. The additive manufacturing device of claim 13, further comprising an internal environmental control mechanism that provides control of a composition of gases within the chamber.
